(19) United States
(12) Patent Application Publication
(10) Pub. No.: US 2013/0058142 A1
(43) Pub. Date: Mar. 7, 2013

(54) POWER SUPPLY DEVICE

(71) Applicants: Haineng WEI, Guangdong (CN); Gangjian XIAO, Guangdong (CN)

(72) Inventors: Haineng WEI, Guangdong (CN); Gangjian XIAO, Guangdong (CN)

(73) Assignee: HUIZHOU FACTORY JECKSON ELECTRIC CO., LTD., Guangdong (CN)

(21) Appl. No.: 13/334,992

(22) Filed: Dec. 22, 2011

(30) Foreign Application Priority Data
Sep. 1, 2011 (CN) 201120325840.7

(51) Int. Cl. H02M 7/217

(52) U.S. Cl. 363/127

(57) ABSTRACT

A power supply device comprising a switch assemble, a voltage transformation circuit and a processor is disclosed. The switch assemble may include a first switch and a second switch connected with each other in parallel. After the first switch turns on, the voltage transformation circuit is electronically coupled to AC power and provides a DC voltage output for powering the processor to turn on initially. The first switch will turn off after the processor is powered up, and the powered processor operates to control the second switch to turn on so that the voltage transformation circuit is coupled to AC power through the second switch and provides DC voltage output for enabling the processor to continue to operate. The processor is further configured to control the second switch to turn off according to performances of a load coupled to the transformation circuit.

### CROSS-REFERENCES TO RELATED APPLICATIONS

This application claims the benefit of CN utility models application No. 201120325840.7 filed on Sep. 1, 2011, entitled “a power supply device”, which is incorporated herein by reference in its entirety.

### TECHNICAL FIELD

The present application relates to a power supply device.

### BACKGROUND

Nowadays, how to reduce energy loss and dissipation becomes a very critical issue due to energy poverty and energy conservation. Particularly, it is very important for home appliance to have the ability of saving energy. For example, the household electrical appliance in China is generally attached with an energy efficiency label. A popular international energy efficiency standard is Energy star. At present, Power Management IC (PMIC) has been available in the market, but such chip is expensive and may cause other new problems, such as the Electro-Magnetic Interference (EMI) of products, etc.

### SUMMARY

There is provided a power supply device, which may comprise a switch, a voltage transformation circuit and a processor. The switch assemble includes a first switch and a second switch connected with each other in parallel. After the first switch turns on, the voltage transformation circuit is electronically coupled to AC power and provides a DC voltage output for powering the processor to turn on initially. The first switch will turn off after the processor is powered up, and the powered processor operates to control the second switch to turn on, so that the voltage transformation circuit is coupled to AC power through the second switch and provides DC voltage output for enabling the processor to continue to operate. Wherein, the processor is further configured to control the second switch to turn off according to performances of a load coupled to the transformation circuit.

### BRIEF DESCRIPTION OF THE DRAWINGS

FIG. 1 illustrates a block diagram of a power supply device according to one embodiment of the present application.

FIG. 2 illustrates a detailed diagram of a power supply device according to one embodiment of the present application.

FIG. 3 illustrates exemplarily a circuit diagram according to one embodiment of the present application, wherein a first switch is electronically coupled to a second switch in parallel and the second switch is a relay.

### DETAILED DESCRIPTION

Hereinafter, some embodiments of the application will be described in reference to the accompanying drawings.

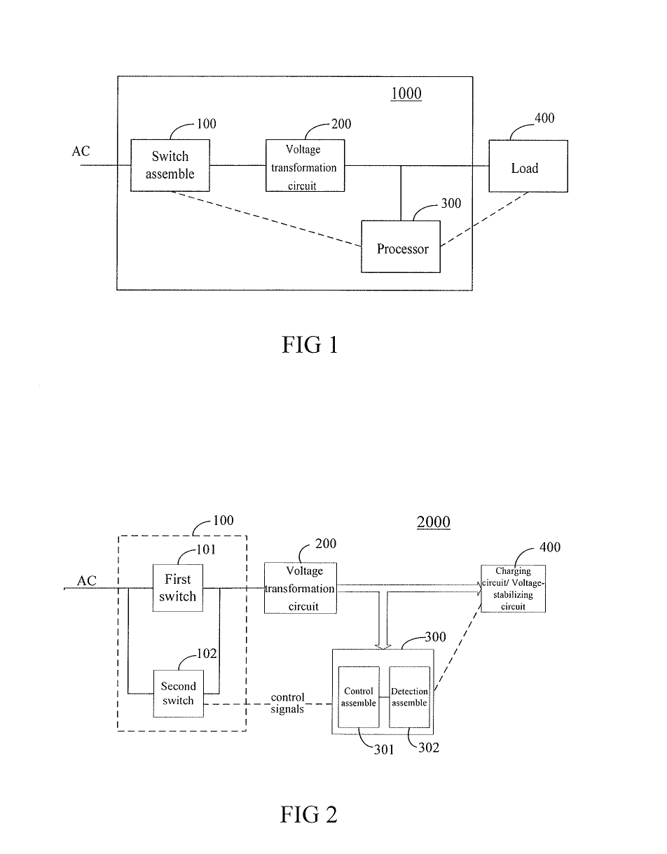

FIG. 1 illustrates exemplarily a block diagram of a power supply device 1000 according to one embodiment of the present application. As shown, the power supply device 1000 comprises a switch assemble 100, a voltage transformation circuit 200 and a processor 300.

The voltage transformation circuit 200 is electronically coupled to AC power through the switch assemble 100. Once the switch assemble 100 turns on, the voltage transformation circuit 200 transforms AC voltage received from the AC power into DC voltage output, such as 5V or lower DC voltage. The DC voltage output from the voltage transformation circuit 200 may be utilized to power a load 400. The load 400 may comprise a charger, a voltage-stabilizing circuit or other circuit, which will be described hereinafter.

The processor 300 is powered up by the DC voltage output, and controls the switch assemble 100 to turn on or off according to the performance of the load 400. For example, where the load 400 does not need to be powered any more, the processor 300 operates to control the switch assemble 100 to be in disconnection with the AC power (i.e. turn off) such that the power supply device 1000 disconnects with the AC power.

FIG. 2 illustrates a power supply device 2000 according to another embodiment of the present application, in which further detailed arrangements of the switch circuit and the processor will be discussed. In addition, for purpose of illustration or description, a charging circuit or a voltage-stabilizing circuit is electronically coupled to the output end of the voltage transformation circuit 200 to serve as the load 400 of the power supply device.

As shown in FIG. 2, the switch assemble 100 comprises a first switch 101 and a second switch 102. The first switch 101 and the second switch 102 are connected in parallel. The first switch 101 may be a mechanical switch, such as a button, which will be disconnected from the AC power when the first switch 101 is on for a predetermined period. The button is pressed down so that the voltage transformation circuit 200 is electrically coupled to the AC power, and thus the voltage transformation circuit 200 transforms the output of the AC power into the DC voltage. The processor is powered up based on the DC voltage, and then the button will be released. In general, the time during which the button is pressed down may be millisecond order of magnitude.

The second switch 102 may comprise an electronic-controllable switch, which will be controlled by the processor 300 to switch on or off. The processor 300 is powered up and then operates to control the second switch 102 to switch on. After the first switch 101 is disconnected (off), the processor 300 controls the second switch 102 to be off according to the performance of the load 400. In this embodiment, the processor 300 comprises a detection assemble 301 and a control assemble 302, and the load 400 comprises a charging circuit for receiving the DC voltage output from the circuit 200 in order to provide charging current, or a voltage stabilizing circuit for stabilizing the DC voltage output from the circuit 200 in order to output stabilized DC voltage.

In case that the load is the charging circuit, the detection assemble 301 is configured to detect charging current of the charging circuit so as to determine if the charging circuit still needs to be provided the charging power. In case that the load is the voltage stabilizing circuit, the detection assemble 301 is configured to detect DC voltage output from the voltage stabilizing circuit so as to determine if the voltage stabilizing circuit still needs to be supplied the power output. If the charging circuit does not need to be provided the charging power or the voltage stabilizing circuit does not need to be supplied the power output, the control assemble 302 will control the second switch 102 to be off, so that the voltage transformation circuit 200 will be disconnected with the AC power.

As an example, in case that the load is the charging circuit, the detection assemble 301 can be provided with an AD voltage detection port. If there is not any cell in the charging circuit, the voltage detected by the AD voltage detection port maybe, for example, +5V. While a cell is provided in the charging circuit, the voltage detected by the AD voltage detection port will be the voltage that the cell itself has, for example less than +5V, and will change with a degree of charging saturation of the cell. In case that the load is the voltage stabilizing circuit, the detection assemble 301 may be provided with an AD voltage detection port or comparison port. Where the voltage transformation circuit is provided with an external load and is consuming energy, the voltage detected by the port is different from that without the load or the load only needs minimal energy, wherein the former generally is higher than the latter. Other detection manners may be suitable as well.

As an alternative embodiment, the power supply device may further comprise an independent charging current circuit or a voltage detection circuit (not shown), which is configured to transmit signal indicating the performance of the load 400 to the processor 300, so that the performance requirement of the processor 300 can be reduced.

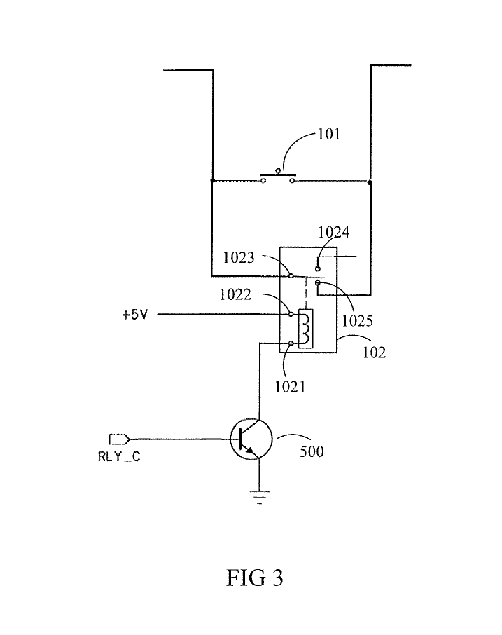

In an embodiment, the second switch 102 may be a relay. FIG. 3 exemplarily illustrates a circuit diagram in which the first switch 101 is electronically coupled to the second switch 102 in parallel, wherein the second switch 102 is a relay. For purpose of clarity, some conventional parts such as a resistance and a diode are omitted in FIG. 3.

As shown in FIG. 3, an input contact 1023 of the relay is electronically coupled to the input end of the first switch 101, and an output contact 1025 of the relay is a normally open contact and is electronically coupled to the output end of the first switch 101. Another output contact 1024 may be suspended, or be connected to other position different from the first switch according to the specific circuit design.

A control coil of the relay comprises two ends 1021 and 1022. As shown in FIG. 3, the end 1022 is electronically coupled to DC voltage. For example, the end 1022 is to the DC voltage output of the voltage transformation circuit 200, while the end 1021 is electronically coupled to a third switch circuit 500. The third switch circuit 500 may be for example a transistor. As shown, a base of the transistor 500 is electronically coupled to the control signals output port (shown as RLY_C in FIG. 3) of the processor 300, a collector of the transistor is electronically coupled to the end 1021 of the control coil of the relay K1, and an emitter of the transistor is electronically coupled to the ground.

When control signals from the processor 300 are high level, the transistor 500 will turn on. At the same time, there will form a passage between the end 1022 of the control coil and the emitter of the transistor, so that the field current can flow through between the ends 1021 and 1022 of the relay K1 and produce electromagnetic effects, which in turn make the contact 1023 electronically coupled to the contact 1025, namely make the second switch 102 turn on. When control signals from the output port RLY_C are low level, the transistor 500 is in a cut-off state, there is not any field current between the ends 1021 and 1022, and the contact 1023 is in disconnection with the contact 1025, namely, the second switch 102 is in a non-conduction state.

Embodiments and implementations of the present application have been illustrated and described, it should be understood that various other changes may be made therein without departing form the scope of the application.

What is claimed is:

1. A power supply device, comprising:
a switch assemble including a first switch and a second switch connected with each other in parallel;
a voltage transformation circuit; and
a processor,
wherein the voltage transformation circuit is electronically coupled to AC power and provides a DC voltage output for powering the processor to turn on initially after the first switch turns on,
wherein the first switch will turn off after the processor is powered up, the powered processor operates to control the second switch to turn on, so that the voltage transformation circuit is coupled to AC power through the second switch and provides DC voltage output for enabling the processor to continue to operate, and
wherein the processor is further configured to control the second switch to turn off according to performances of a load coupled to the transformation circuit.

2. A device according to claim 1, wherein the first switch comprises a mechanical switch.

3. A device according to claim 1, wherein the load comprises a charging circuit for receiving DC voltage output from the voltage transformation circuit to supply charging current.

4. A device according to claim 3, wherein the processor comprises:
a detection assemble configured to detect the charging current to determine whether or not to continue to supply charging power to the charging circuit; and
a control assemble configured to control the second switch to turn off so that the voltage transformation circuit is in disconnection with the AC power when the detection assemble determines that the charging circuit does not need to be powered any more.

5. A device according to claim 1, wherein the load comprises a voltage-stabilizing circuit configured to receive DC voltage output from the voltage transformation circuit and stabilize the received DC voltage to output stabilized DC voltage.

6. A device according to claim 5, wherein the processor comprises:
a detection assemble configured to detect DC voltage output from the voltage transformation circuit to determine whether or not to continue to supply output power to the voltage transformation circuit; and
a control assemble configured to control the second switch to turn off so that the voltage transformation circuit is in disconnection with the AC power when the detection assemble determines that the voltage transformation circuit does not need to be powered any more.

7. A device according to claim 1, wherein the second switch is a relay.

8. A device according to claim 7, wherein the relay comprises an input contact and a normally open contact, wherein the input contact is connected to an input end of the first switch, the normally open contact is connected to an output end of the first switch, and wherein when the relay receives signals for controlling the relay to turn on from the processor, the input contact will be connected to the normally open contact so that the relay turns on.

9. A device according to claim 8, wherein the relay further comprises a control coil, wherein, in case that the relay receives the signals from the processor, current will flow through the control coil to produce electromagnetic energy, which in turn makes the input contact be connected to the normally open contact.

10. A device according to claim 9, further comprises a third switch located between the control coil and the processor and configured to control whether or not to generate the current in the control coil.

11. A device according to claim 10, wherein the third switch comprises a transistor, wherein a base of the transistor is electrically coupled to the processor, a collector of the transistor is electrically coupled to the control coil, and a emitter of the transistor is electrically coupled to ground.
